(19) United States
(12) Patent Application Publication
(10) Pub. No.: US 2004/0191561 A1
(43) Pub. Date: Sep. 30, 2004

(54) Surface structure of metallic body

(75) Inventor: Motohiko Otsuki, Miyagi-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/807,687

(22) Filed: Mar. 24, 2004

(30) Foreign Application Priority Data
Mar. 28, 2003 (JP) 2003-092022

(51) Int. Cl. B32B 15/00

(52) U.S. Cl. 428/672; 428/680; 428/670

(57) ABSTRACT

A surface structure of a metallic body capable of properly maintaining the surface state of a gold layer by preventing diffusion of nickel under conditions of high temperature is provided. In the surface structure of a metallic body of a metal substrate plated with gold, the surface structure includes a nickel layer formed on the surface of the substrate, a barrier layer formed from one or more elements selected from Group 8A of the periodic table formed on the surface of the nickel layer, and a gold layer formed on the surface of the barrier layer.

### BACKGROUND OF THE INVENTION

1. Field of the Invention

The present invention relates to a surface structure of a metallic body consisting of a metal substrate plated with gold (Au), and more particularly, to a surface structure of a metallic body consisting of a nickel (Ni) layer as a base and a gold (Au) layer.

2. Description of the Related Art

In the past, a metallic body cannot be directly plated with gold (Au) due to adhesion problems. Instead, the metallic body is first plated with nickel (Ni), and then the surface of the nickel is plated with gold. If the metallic body is exposed to a high temperature and is applied with repetitive voltage, the nickel in the nickel layer diffuses into the gold layer and exposes the surface of the gold layer. If the nickel migrates in this fashion, the surface of the nickel layer is oxidized and the benefit of plating the surface of the metallic body with the gold disappears.

For example, when a lens barrel holding an optical element is installed by soldering the outer peripheral surface of the lens barrel, the outer peripheral surface of the lens barrel is plated with the gold. If the gold plating is carried out prior to the lens barrel being provided with the optical element, the costs of manufacturing the appliance to which the lens barrel is applied are decreased. However, if the lens in the lens barrel is formed from glass, this glass is treated with a softening process in order to form the optical element. Accordingly, the plated lens barrel is exposed to a high temperature causing migration of the nickel when the lens barrel is formed with the optical element. In addition, if a contact portion of a switch is plated with gold, voltage is repeatedly applied to the contact portion of the switch again causing migration of the nickel.

In order to prevent the above migration phenomenon, a surface structure of the metallic body with a thick gold layer has been proposed by Patent Document 1. Since the conventional lens barrel for the optical element utilizes glass having a relatively low melting point of 400° C. to 450° C. as material of the optical element, such a structure can prevent the migration to a certain degree. However, if glass having a high melting point of above 500° C. is utilized in forming the optical element, the above migration still occurs.

[Patent Document 1]

Japanese Unexamined Patent Application Publication No. 10-261730

FIGS. 7 to 10 are graphs depicting measured values of the composition in the surface structure of the metallic body consisting of the nickel layer as a base and the gold layer. In the graphs, the abscissa indicates the depth of the gold layer, with “0” defining the outermost surface. Also, the ordinate indicates composition ratio for gold, nickel and oxygen (O) contained in the gold layer. In addition, since carbon is present in the vicinity of the surface of the gold layer, carbon is detected at the position closely adjacent to the surface of the gold. However, the carbon does not appear to be related to the migration, and thus the analysis for the carbon is omitted. Here, the nickel layer is formed as a base with a thickness of 2 to 3 μm, and the gold layer is formed on the surface of the nickel layer in a thickness of 2 to 3 μm. The glass is softened to form the lens using by heating the metallic body at 570° C. for four minutes under a nitrogen atmosphere. In addition, the metallic body is heated at 350° C. for four hours under atmosphere to oxidize the structure.

FIG. 7 depicts the composition when the gold layer is formed on the nickel layer, but the structure is not treated with the heating process. In this case, the nickel is hardly diffused. FIG. 8 depicts the composition when only baking is performed. In this case, the nickel is broadly diffused into the gold layer, and migration occurs. Also, the concentration of oxygen is increased at a position adjacent to the surface, thereby indicating the occurrence of oxidization. FIG. 9 depicts the composition when only oxidization-accelerating heat is applied. In this case, the nickel is diffused into the surface of the gold layer, and a similar distribution is indicated for the oxygen. FIG. 10 depicts the composition when baking and oxidization-accelerating heat is performed. In this case, the nickel is broadly diffused into the gold layer, and the oxidization is performed in depth.

As described above, with the surface structure of a conventional metallic body consisting of the nickel layer as a base and the gold layer, if the metallic body is exposed to a high temperature of above 500° C., migration of the nickel occurs, and also the nickel exposed to the surface thereof is oxidized in the atmosphere, thereby losing the plating effect of the gold. As a result, it is not possible to carry out soldering on the lens barrel for the optical element. In addition, when the nickel migrates due to the current flowing through the metallic body, the contact portion of the switch fails.

### SUMMARY OF THE INVENTION

Accordingly, embodiments of the present invention provide a surface structure of a metallic body capable of properly maintaining the surface state of a gold layer by preventing diffusion of nickel under conditions of high temperature.

According to the present invention, there is provided a surface structure of a metallic body containing a metal substrate plated with gold, the surface structure comprising: a nickel layer formed on the surface of the substrate; a barrier layer of element selected from Group 8A of the periodic table formed on the surface of the nickel layer; and a gold layer formed on the surface of the barrier layer.

According to the present invention, it can suppress the diffusion of the nickel into the gold layer from the nickel layer by the barrier layer under conditions of high temperature.

Further, in the surface structure of the metallic body according to the present invention, the barrier layer is made of rhodium (Rh).

In addition, in the surface structure of the metallic body according to the present invention, the substrate is made of stainless steel.

In addition, in the surface structure of the metallic body according to the present invention, the substrate is a cylindrical lens barrel holding an optical element, the nickel layer, the barrier layer and the gold layer are formed on the outer peripheral surface of the lens barrel.

According to the present invention, even though a glass having a high melting point is utilized as a material of the optical element, it is possible to form the optical element, without the migration of nickel on the surface of the lens barrel.

### BRIEF DESCRIPTION OF THE DRAWINGS

FIG. 1 is a sectional schematic view of a surface structure of a metallic body according to a preferred embodiment of the present invention;

FIG. 2 is a sectional view of a lens barrel according to a preferred embodiment of the present invention;

FIG. 3 is a graph of composition vs. depth before a surface structure of a metallic body according to a preferred embodiment of the present invention is heated;

FIG. 4 is a graph of composition vs. depth after a surface structure of a metallic body according to a preferred embodiment of the present invention is baked;

FIG. 5 is a graph of composition vs. depth after a surface structure of a metallic body according to a preferred embodiment of the present invention is treated through an oxidization-accelerating heating;

FIG. 6 is a graph of composition vs. depth after a surface structure of a metallic body according to a preferred embodiment of the present invention is treated through a baking and an oxidization-accelerating heating;

FIG. 7 is a graph of composition vs. depth before a surface structure of a conventional metallic body is heated;

FIG. 8 is a graph of composition vs. depth after a surface structure of a conventional metallic body is baked;

FIG. 9 is a graph of composition vs. depth direction after a surface structure of a conventional metallic body is treated through an oxidization-accelerating heating; and

FIG. 10 is a graph of composition vs. depth after a surface structure of a conventional metallic body is treated through a baking and an oxidization-accelerating heating.

### DESCRIPTION OF THE PREFERRED EMBODIMENTS

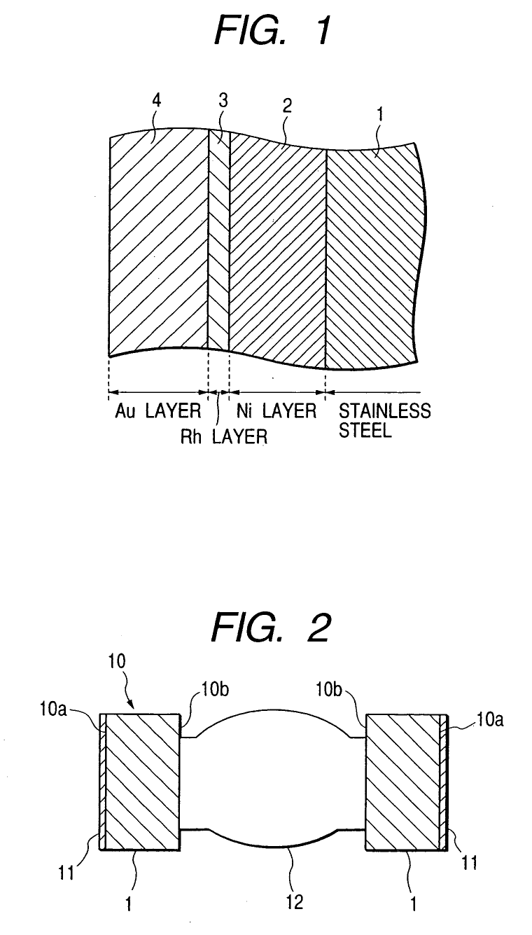

Preferred embodiments of the present invention will now be described with reference to the accompanying drawings. FIG. 1 is a sectional schematic view of a surface structure of a metallic body according to a preferred embodiment of the present invention. FIG. 2 is a sectional view of a lens barrel according to a preferred embodiment of the present invention. First of all, the surface structure of the metallic body according to the present invention will now be described. The surface structure of the metallic body according to the present invention includes a substrate 1 made of metal and a plating layer formed on the surface of the substrate 1, as shown in FIG. 1. In this embodiment, the substrate 1 is made of stainless steel.

A nickel layer 2 to be a base is formed on the surface of the substrate 1. The nickel layer 2 has a thickness of 2 to 3 μm. A barrier layer 3 made of rhodium (Rh) is formed on the surface of the nickel layer 2. The barrier layer 3 has a thickness of 0.1 to 0.3 μm. Further, a gold layer 4 is formed on the surface of the barrier layer 3. The gold layer 4 has a thickness of 2 to 4 μm. The above thickness of the respective layers is not limited to the above values; for example although the barrier layer 3 is much thinner than either the nickel layer 2 or the gold layer 4, this need not be the case. Also, although the rhodium is utilized as the material of the barrier layer 3, the present invention is not limited thereto. Any element of Group 8A in the periodic table, for example palladium (Pd) or platinum (Pt), may be used.

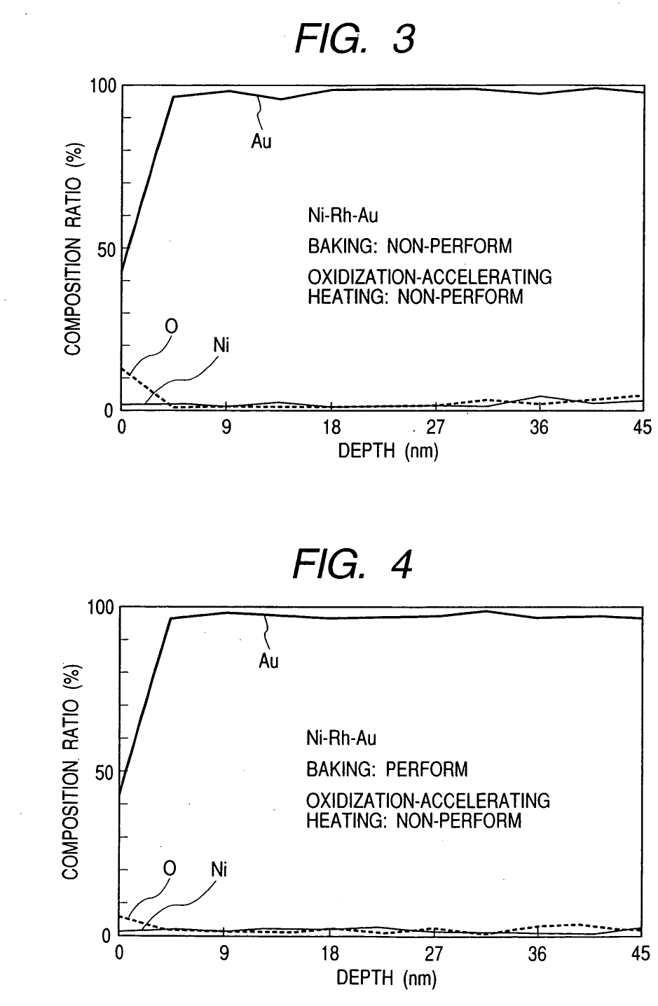

For the above embodiment, measured values of the composition distribution in the vicinity of the surface of the gold layer 4 are depicted in FIGS. 3 to 6. In the graphs, the abscissa is the depth of the gold layer 4, and “0” is defined to be the outermost surface. In addition, the ordinate is the composition ratio for gold, nickel and oxygen contained in the gold layer 4. In addition, since carbon is adhered to the vicinity of the surface of the gold layer 4; the carbon is detected at the position closely adjacent to the surface of the gold. However, since carbon bears no relation to migration of nickel, the analysis for the carbon is omitted.

FIG. 3 depicts the composition distribution in the vicinity of the surface of the metallic body according to a preferred embodiment of the present invention. If heating is not performed, the oxygen ratio is increased somewhat in the vicinity of the surface, but oxidization and migration of the nickel hardly occurs. The below description shows how the oxidization and the migration of the nickel progress on the surface by carrying out the baking at a high temperature, such as during the formation of glass, and by carrying out the oxidization-accelerating heating at a relative low temperature, such as during oxidization for an extended period under atmosphere.

FIG. 4 depicts the composition distribution in the vicinity of the surface of the metallic body according to a preferred embodiment of the present invention after baking. The baking condition is identical to that described above, and the metallic body is heated at 570° C. for 4 minutes under a nitrogen atmosphere. In this case, the composition distribution is substantially similar to that shown in FIG. 3, which depicts the state before the baking is carried out. In other words, even though the baking is carried out at 570° C., the nickel is hardly diffused into the gold layer 4 due to the barrier layer 3 interposed between the nickel layer 2 and the gold layer 4. Accordingly, the migration hardly occurs. FIG. 8 depicts the composition distribution, after the baking, according to a conventional metallic body having no barrier layer 3. Compared to FIG. 8, the migration depends significantly upon the existence of the barrier layer 3.

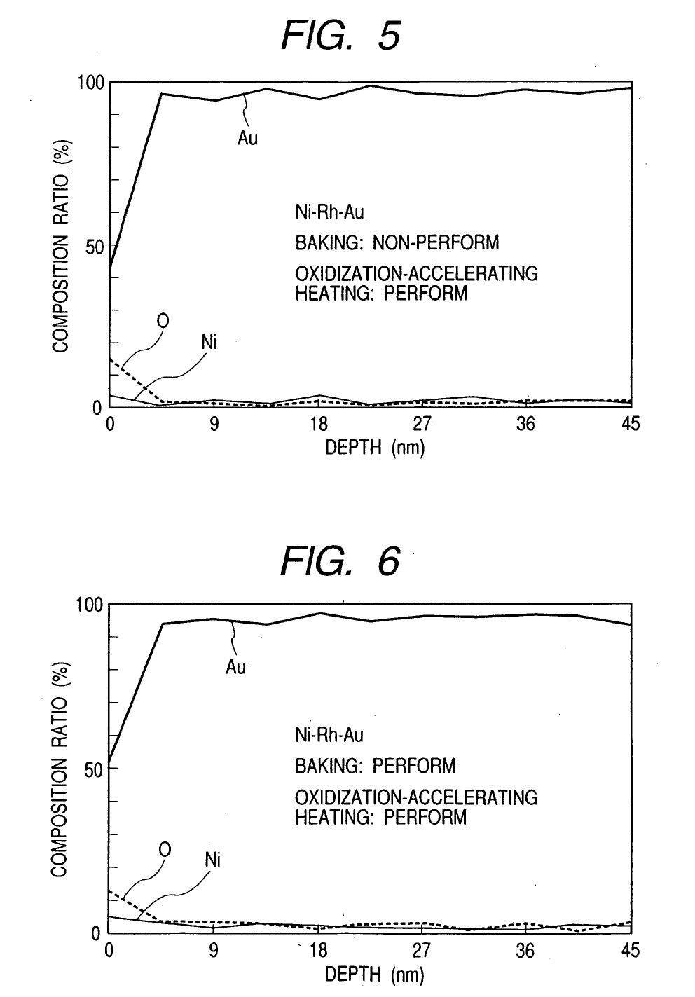

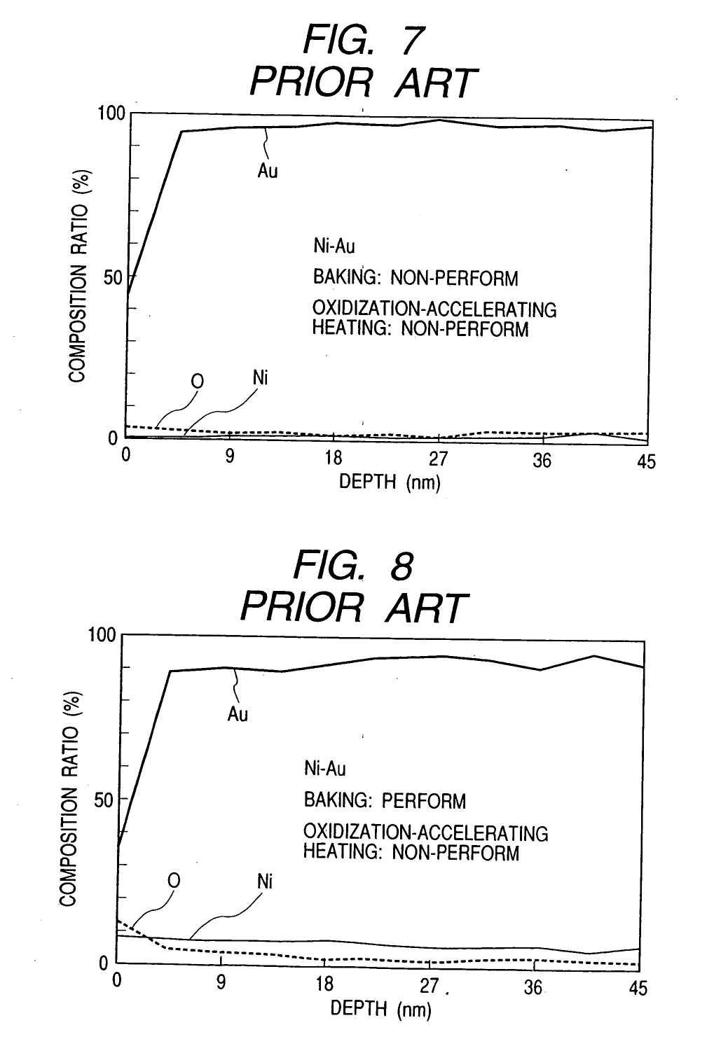

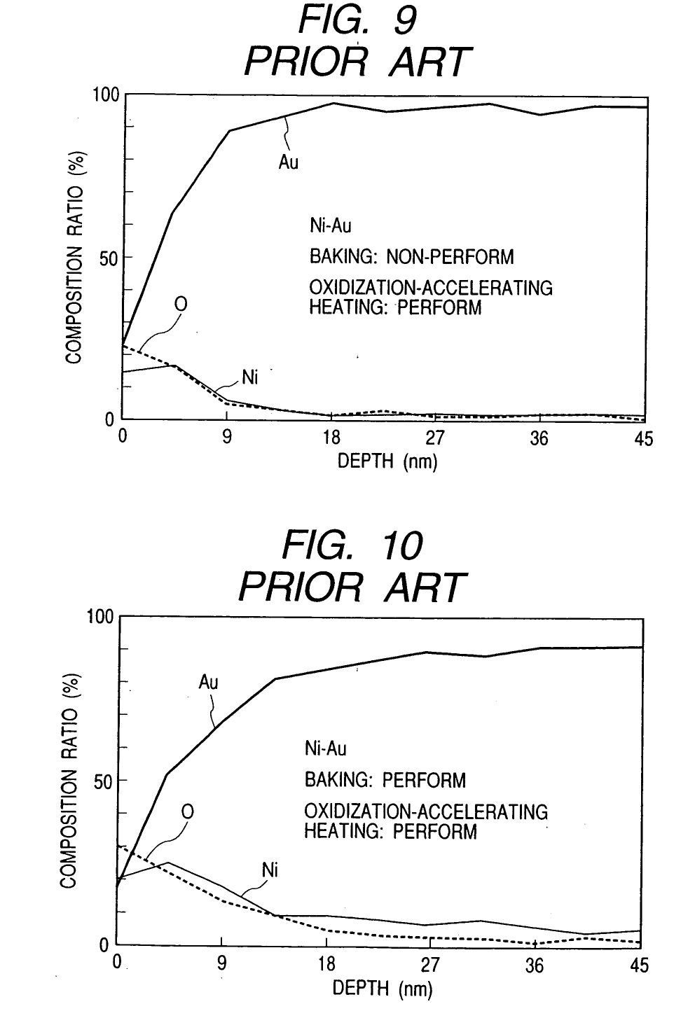

FIG. 5 depicts a distribution of composition in the vicinity of the surface of the metallic body according to a preferred embodiment of the present invention after carrying out the oxidization-accelerating heating. The oxidization-accelerating heating conditions are identical to that described above, and the metallic body is heated at 350° C. for 4 hours under the atmosphere. In this case, the composition distribution is substantially similar to that shown in FIG. 3, which depicts the state before the oxidization-accelerating heating is carried out. Compared to FIG. 9 depicting the composition distribution after the oxidization-accelerating heating according to a conventional metallic body having no barrier layer 3, it is apparent that the oxidization depends significantly upon the existence of the barrier layer 3. In other words, since it is the nickel that oxidizes, it is difficult for the oxidization to occur on the surface of the metallic body according to the present invention, in which the nickel is hardly diffused into the gold layer 4. FIG. 9 depicts the composition distribution, after carrying out the oxidization-accelerating heating, according to a conventional metallic body having no barrier layer 3. Compared to the graph showing the composition of the present invention, it is apparent that the oxidization occurs hardly on the outermost surface in the surface structure of the metallic body according to the present invention.

FIG. 6 depicts the composition distribution in the vicinity of the surface of the metallic body according to a preferred embodiment of the present invention after carrying out the baking and the oxidization-accelerating heating. The baking and the oxidization-accelerating heating conditions are identical to those described above, and the metallic body is heated at 570° C. for 4 minutes under the nitrogen atmosphere and then heated at 350° C. for 4 hours under the atmosphere. In this case, the composition distribution is substantially similar to that shown in FIG. 3, which depicts the state before the baking and the oxidization-accelerating heating are carried out. As a result, since the surface structure of the metallic body is provided with the barrier layer 3, it is possible to prevent the diffusion of the nickel into the surface of the gold layer, thereby suppressing migration. Further, the oxidization of the surface of the nickel is reduced to properly maintain the surface state of the gold layer 4. Compared to FIG. 10 depicting the composition distribution obtained under the same conditions according to a conventional metallic body having no barrier layer 3, it is apparent that migration and oxidization hardly occur in the surface structure of the metallic body according to the present invention.

A method of manufacturing the surface structure of the metallic body will now be described. These layers are formed on the surface of the substrate 1 by electroplating. That is, first, after the substrate 1 is pretreated, using acid cleaning or some similar cleaning method, the substrate 1 is immersed into an electrolytic solution of nickel, and a current is applied to form the nickel layer 2. Next, the substrate 1 plated with the nickel layer 2 is immersed into an electrolytic solution of rhodium, and a current is applied to form the rhodium barrier layer 3. Since the barrier layer 3 is very thin compared with the nickel layer, flash plating is carried out. Finally, the substrate 1 plated with these layers is immersed into an electrolytic solution of gold, and a current is applied to form the gold layer 4.

The present invention relates to the surface structure of the metallic body. In the present invention, a shape of the metallic body is not limited. In this embodiment, the present invention is applied to a lens barrel 10 with an optical element 12 received therein, as shown in FIG. 2. The lens barrel 10 is made of cylindrical stainless steel, and accommodates the optical element 12 in the inner peripheral surface 10b thereof. The outer peripheral surface 10a of the lens barrel is secured to an appliance utilizing the optical element 12 by soldering. In this embodiment, the optical element 12 is a lens. However, the present invention is not limited thereto, and also is not limited to a shape of the optical element 12.

Since it is not possible to carry out the soldering on the lens barrel 10 made of the stainless steel as it is, the surface of the lens barrel is plated with gold. The gold plating is carried out on at least the outer peripheral surface 10a of the lens barrel 10 to form the plating layer 11. The plating layer 11 is configured as the surface structure of the metallic body described above. The nickel layer 2 is formed on the surface of the substrate 1, the rhodium barrier layer 3 is formed on the surface of the nickel layer 2, and the gold layer 4 is formed on the surface of the barrier layer 3. In FIG. 2, since the plating layer 11 has a thickness of several micrometers, the plating layer 11 is shown larger than scale.

The optical element provided with such a lens barrel is manufactured as follows: First, the lens barrel 10 plated according the above process is prepared, and then glass forming the optical element 12 is disposed and framed in the lens barrel. The glass is then heated at a softening temperature to soften the glass. The softened glass is then pressed, so that a shape of the frame is transferred to the glass to form the optical element 12. Accordingly, the lens barrel 10 with the plating layer is heated at the softening temperature of the glass.

Since the lens barrel 10 includes the surface structure of the metallic body according to the present invention on the outer peripheral surface 10a thereof, migration does not occur at the high temperatures used. Accordingly, even though the glass has a high melting point, the surface state of the outer peripheral surface 10a can be properly maintained, thereby not interrupting the soldering. In other words, the designer has more degrees of freedom to select the type of glass used to form the optical element 12 than in conventional structures.

As described the above, with the surface structure of the metallic body according to the present invention, since a barrier layer formed from one or more elements selected from Group 8A in the periodic table is formed on the surface of a nickel layer, the nickel is not diffused into the gold by the barrier layer. As a result, it is possible to prevent migration of the nickel even under high temperature conditions.

In addition, with the surface structure of the metallic body according to the present invention, the substrate is the cylindrical lens barrel holding the optical element, and the nickel layer, the barrier layer and the gold layer are formed on the outer peripheral surface of the lens barrel. In the case of utilizing the glass having a high melting point as a material of the optical element, although the lens barrel is exposed to the high temperature at the time of forming the optical element, the surface state of the outermost surface can be properly maintained, thereby securely performing the soldering.

What is claimed is:

1. A surface structure of a metallic body containing a metal substrate, the surface structure comprising:
a nickel (Ni) layer formed on a surface of the substrate;
a barrier layer of one or more elements selected from Group 8A of the periodic table formed on a surface of the nickel (Ni) layer; and
a gold (Au) layer formed on a surface of the barrier layer.

2. The surface structure of a metallic body according to claim 1,
wherein the barrier layer is made of rhodium (Rh).

3. The surface structure of a metallic body according to claim 1,
wherein the substrate is made of stainless steel.

4. The surface structure of a metallic body according to claim 1,
wherein the substrate is a cylindrical lens barrel holding an optical element, the nickel layer, the barrier layer and the gold layer are formed on an outer peripheral surface of the lens barrel.

5. The surface structure of a metallic body according to claim 2,
wherein the substrate is a cylindrical lens barrel holding an optical element, the nickel layer, the barrier layer and the gold layer are formed on an outer peripheral surface of the lens barrel.

6. The surface structure of a metallic body according to claim 3,
wherein the substrate is a cylindrical lens barrel holding an optical element, the nickel layer, the barrier layer and the gold layer are formed on an outer peripheral surface of the lens barrel.
